(19) United States
(12) Patent Application Publication
(10) Pub. No.: US 2010/0078260 A1
(43) Pub. Date: Apr. 1, 2010

(54) Acoustical sound barrier material

(76) Inventor: Jerry J. McNeal, JR., North East, MD (US)

Correspondence Address: Ober, Kaler, Grimes & Shriver;Royal W. Craig, 120 East Baltimore Street, Baltimore, MD, 21202-1643, US

(21) Appl. No.: 12/586,776

(22) Filed: Sep. 28, 2009

Related U.S. Application Data
(60) Provisional application No. 61/194,274, filed on Sep. 26, 2008.

(51) Int. Cl. E04B 1/82; B05D 3/12

(52) U.S. Cl. 181/290; 252/62; 427/369

(57) ABSTRACT

The present composition is a mixture of pozzolanic binder, recycled raw cellulosic materials (mineralized softwood chips and/or particles, hardwood chips and/or particles or a combination of the two and wood based construction waste), sand, ash and/or ground slag that when cured, forms a sound absorptive product and suitable for use in all climates and weather conditions. The primary use for the present composition is for highway sound barrier walls but the product can also be used in any application where a durable sound absorptive material is required, including rail, industrial, tunnel, residential, and existing wall retro-fit applications. The present composition can be used as an absorptive panel or cast monolithically with reinforced concrete which forms a structural and absorptive precast concrete panel.

### CROSS-REFERENCE TO RELATED APPLICATIONS

The present application derives priority from provisional application 61/194,274 filed on Sep. 26, 2008 which is incorporated herein by reference in its entirety.

### BACKGROUND OF THE INVENTION

1. Field of the Invention

The present invention relates generally to acoustic attenuation and vibration damping materials and, more specifically, to a blended cement composition for use as a sound absorptive barrier in both existing and retrofit highway, rail, industrial, tunnel and residential applications.

2. Description of the Background

Sound insulation materials are used in numerous applications to dampen ambient noise and typically rely on a combination of sound absorption and scattered reflection to provide adequate noise reduction. Sustained high levels of noise are both unsafe and unhealthy to exposed individuals. In areas of high population density such as urban and suburban centers, people are increasingly living and working within earshot of loud, incompatible land uses such as industrial facilities, airports, rail lines and highways. It has become common for states and municipalities to plant vegetation, raise berms and erect sound walls around such noise sources to harmonize adjacent, incompatible uses.

A variety of conventional acoustical insulation materials have been implemented in the construction of structures such as homes and offices in an attempt to lower the infiltration of ambient noise into the living/working spaces of the structure. Such materials include foams, fiberglass batts, mats, woven and non-woven webs, and multi-layer laminates. These sound dampening materials, in conjunction with other building techniques, can be successful in reducing indoor ambient noise but are expensive, environmentally sensitive or otherwise not well suited for large-scale exterior applications requiring bulk material such as are necessary when erecting sound barrier walls to isolate highway or similar noise sources. The ideal sound-dampening composite material for such outdoor applications would be structurally sound, insensitive to/temperature, weather and pests, and incorporate low-cost raw materials so as to be inexpensive to produce and utilize. Even more desirable would be the ability to incorporate readily-available wastes materials such as construction and industrial wastes that would otherwise be disposed of in landfills. It would be greatly advantageous to provide an effective acoustic-reduction composite material formed from recycled wood construction waste for large scale applications.

There have been a few attempts at developing a sound-absorptive material utilizing wood and wood products. For example, U.S. Pat. No. 7,341,620 to Walter, et al., discloses a method of producing a sound-absorbing and fire-insulating wall covering comprised of a mixture of 5-20% by weight mineralized wood fibre, 20-60% by weight sand with an SiO₂ content of less than 5% by weight and a greywacke content of at least 30% by weight, and 20-50% by weight cement, which is then molded and cured.

U.S. Pat. No. 5,539,163 to Anderson, et al. discloses a method of producing a lightweight low profile sound wall panel constructed of DURISOL®. DURISOL® is the trade name of a material comprised of mineralized wood shavings and chips (comprised in part of softwood aggregates, by-products of the lumber industry and recycled wood from building and post-construction waste) bonded together with Portland cement. This invention is used to construct panels comprised of an inner slab of DURISOL®, steel reinforcing layers and grout curtains on both sides of the inner slab, and outer slabs on both sides of DURISOL®. DURISOL® is not comprised of a mixture of both hardwood and softwood chips and/or particles. Further, this invention does not provide for application to an existing wall or reinforced concrete wall, and does not provide for construction incorporating an inner reinforced concrete slab between two outside layers of DURISOL®.

U.S. Pat. No. 4,325,457 to Docherty, et al. discloses a method of constructing an acoustic sound barrier panel comprised of mineralized organic materials (including softwood or hardwood shavings) blended with Portland cement. This material is alternately described as DURISOL® within the patent. This material is prepared as a steel reinforced slab that is laminated to a second slab of concrete.

U.S. Pat. No. 5,564,241 to Ogorchock, et al. discloses a method of constructing a sound barrier panel including an acoustic layer comprised of chipped rubber and cord fiber from tires and a structural concrete layer bonded to the acoustic layer by a combination composite bond that includes both a mechanical portion and a chemical portion.

U.S. Pat. No. 5,324,469 to Walter et al. discloses a cast sound absorption panel comprised of a single wood concrete layer of kaolin mineralized organic fiber chips encased in Portland cement with steel reinforcement.

U.S. Pat. No. 5,196,061 to Thomas et al. discloses a method for creating a cement composite incorporating cellulosic waste materials comprised of sludge produced by paper recycling plants. The material disclosed in the '061 patent does not appear to possess sound absorptive properties.

While all the prior art references incorporate some organic materials in combination with cement, they are not optimal for use as a sound absorptive material.

### SUMMARY OF THE INVENTION

It is, therefore, the primary object of the present invention to provide a novel mixture including a cement, industrial waste and wood-based construction waste that can be formed into walls, panels and various other shapes and that, when cured, forms a sound absorptive product that can be used in highway, rail, industrial, tunnel, residential and other sound attenuation wall construction for both new construction and retrofit applications. The mixture is comprised of a mixture of a non-Portland cement based pozzolanic binders including reactive residual materials such as fly ash or granulated slag, sand, chemically mineralized softwood chips and/or particles, chemically mineralized hardwood chips and/or particles, and chemically mineralized wood based construction waste. The resulting composite may be cast and cured into a panel for application to a substrate, the panel being lightweight yet strong and fully sound-dampening through absorption and scattered reflection. In addition, the composite may be cast monolithically with reinforced concrete on one or both sides to form a structural and absorptive precast concrete panel for use in all highway conditions and meeting all wind load and other requirements. The composite may also be directly applied to existing walls to provide a sound absorptive facing.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side view of a use of the invention on one side of structural concrete.

FIG. 2 is a side view of a use of the invention on both sides of structural concrete.

FIG. 3 is a side view of a use of the invention showing the invention attached to an existing wall.

### DETAILED DESCRIPTION OF THE PREFERRED EMBODIMENT

For the purposes of promoting an understanding of the principles of the invention, reference will now be made to the exemplary embodiment illustrated in the drawings and described below. The embodiments disclosed are not intended to be exhaustive or limit the invention to the precise form disclosed in the following detailed description. Rather, the embodiment is chosen and described so that others skilled in the art may utilize its teachings. It will be understood that no limitation of the scope of the invention is thereby intended. The invention includes any alterations and modifications in the illustrated embodiments and the composition from which they are made which is the subject of the present application, along with further applications of the principles of the invention which would normally occur to one skilled in the art to which the invention relates.

The composition of the present invention is a blend of pozzolanic binder, chemically mineralized softwood and/or hardwood chips and/or particles, chemically mineralized wood-based construction waste, mortar sand and in some cases residual materials such as ash, fly ash and granulated slag or metal oxide and phosphate based composite materials containing such reactive residual materials. The elements of the composition, after mixing with water, are cast alone or monolithically in conjunction with conventional concrete to form panels of varying sizes which may be erected by conventional means to form sound attenuation barriers of any desired length. Alternately, panels of the presently disclosed composite material alone may be applied to an existing substrate such as a concrete wall to add or enhance sound attenuating characteristics.

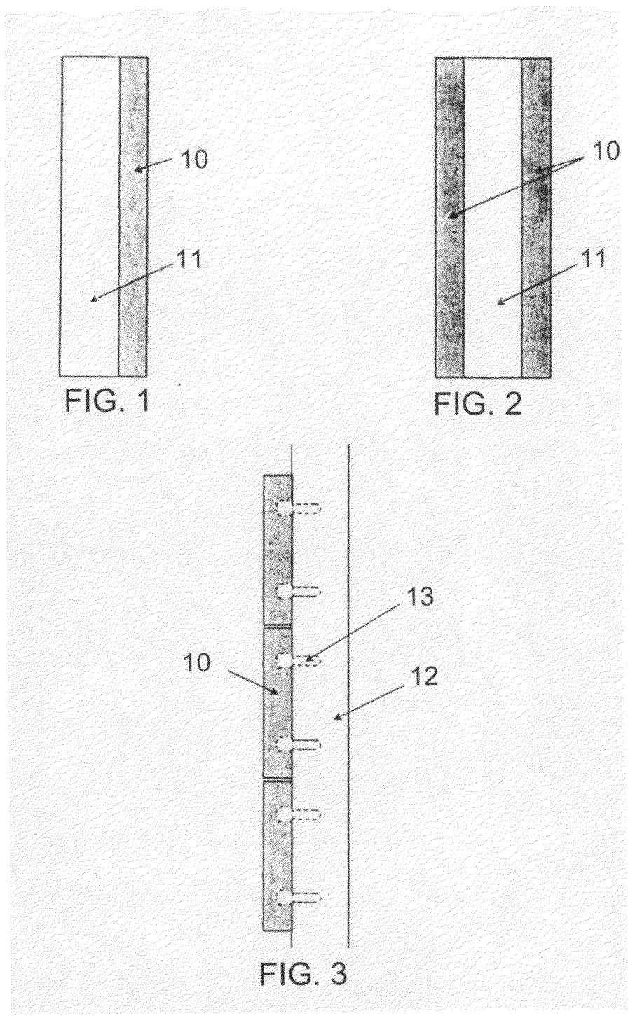

FIG. 1 depicts a first embodiment of the present invention and includes a single layer 10 of the present composition monolithically cast to a single reinforced concrete layer 11. Concrete layer 11 may be made from conventional concrete incorporating Portland cement and aggregates or may incorporate non-Portland cement binders as further described below. Concrete layer 11 may be a precast panel or plank. The panel, laid flat, is surrounded at its perimeter with formwork and layer 10 of the present composition pour thereon and allowed to cure forming a monolithic unit. A concrete bonding agent may be used at the surface of the panel or plank to enhance the bonding of the two layers, 10 and 11. Alternately, a nelson stud or similar embed (not shown) may be provided to enhance the bond between the layers.

With continued reference to FIG. 1, reinforced concrete layer 11 and composition layer 10 may be cast simultaneously. A casting bed or smooth steel form is prepared in a conventional manner as for precast panels or tilt-wall construction. Panels may be cast either face up (acoustical composition layer cast on top of reinforced concrete), or face down which is the preferred arrangement. When cast simultaneously, a casting bed is prepared as above with the maximum standard panel size being approximately 24′×8′. The acoustical composition material is mixed (as described below) and pour into the prepared casting bed. The preferred thickness of the acoustical layer is from 2″ to 4″. A zero slump mix of the acoustical composition material is preferred. The layer is tamped in place. Sand chairs or similar flat bottom or wire rebar chairs may be set on the tamped surface in order to support structural reinforcing steel to be cast within the structural layer. The reinforcing steel is set and the structural concrete layer is poured directly on the acoustical composition layer, preferably immediately after tamping the acoustical composition layer or as soon as possible thereafter but in any event not more than 90 minutes thereafter. The structural concrete layer is preferably 3″ to 6″ thick depending on overall panel size with 5″ preferred thickness. Lifting inserts or other embeds may be inserted into the structural concrete layer 11 and are positioned to insure minimal stresses are imposed during stripping and handling according to practices that are known in the industry. When cast face up, tall chairs, wire ties or masonry type reinforcing ladders may be used to span the reinforced concrete layer/composite layer interface to enhance layer bonding. Initial setting of the structural concrete layer may be desirable before pouring the upper acoustic layer. A slightly higher slump may be desirable when pouring the upper acoustic layer.

FIG. 2 shows an alternate embodiment of the present invention in which a layer 10 of the present composition is monolithically cast on both sides of a single precast reinforced concrete layer 11. Such an embodiment is manufactured using the same principles identified above with respect to the single sided embodiments of FIG. 1.

FIG. 3 shows a further alternate embodiment of the present invention in which a layer 10 of the present composition is attached to an existing wall such as a reinforced concrete wall 12 using a conventional anchoring system 13. Anchoring system 13 may be any known anchoring system capable of supporting the weight of layer 10 such as rebar reinforcing tendons or dowels. Dowels or tendons may be secured in holes drilled into wall 12 by epoxy such as J-50 Sure-Anchor Epoxy by Dayton Superior Corporation of Dayton, Ohio, or similar. Layer 10, in this retrofit application, is pre cast in panelized form as described above without a structural layer before being field applied to wall 12. Minimum panel thickness is 2″.

The composition of the present invention utilized in layer 10 is a blend of pozzolanic binder, chemically mineralized softwood and/or hardwood chips and/or particles, chemically mineralized wood-based construction waste and mortar sand. The term “pozzolanic binder” as used herein encompasses a category of materials that may be synthesized by alkali-activation of aluminosilicates and are variously referred to in certain forms and contexts as geopolymers, geopolymer cement, low temperature aluminosilicate glass, alkali-activated cement, geocement, alkali-bonded ceramics, inorganic polymer concrete or hydroceramics. Pozzolanic binders are based on the pozzolonic reaction between chemically reactive silica or aluminosilicate and a soluble alkali such as KOH, NaOH, K₂SiO₃ or Na₂SiO₃. The pozzolans can be obtained from a range of sources including natural siliceous deposits (often of volcanic origin), fly ash, blast furnace slag or fumed silica. Alternately, pozzolans can be made by calcinating kaolinitic soils or mine wastes containing aluminosilicate clays. In a preferred embodiment the pozzolanic binder component is within a range of from 25%-40% inclusive by total volume of the final dry composition, 30% being presently preferred. Alternately, a metal oxide and phosphate based composite material binder such as magnesium phosphate cement may be utilized at a similar constituency by volume in conjunction, if desired, with bulk active residuals such fly ash and granulated slag.

PAVEMEND™ and READIMAX™ non-portland cement “concrete” products by Ceratech, Inc. of Baltimore, Md. are examples of two such pozzolanic and/or metal oxide/phosphate based composite materials. Use of pozzolanic binders enables the elimination of the use of Portland cement and thereby a reduction in the overall carbon footprint of the composite material in as much as the production of Portland cement is a high CO₂ generating process. In an alternate embodiment, bulk fly ash, granulated blast furnace slag, fumed silica or other waste pozzolans may substitute for a portion of the pozzolanic binders in an approximately one-for-one replacement up to 5% by volume.

Mortar sand is also provided at approximately 5% by volume. Mortar sand should be a natural or manufactured sand blend, rounded to sub-angular in shape, washed and well graded, preferably in accordance with the ASTM C 144 Standard Specification for Aggregates Used in Masonry. Strict compliance with the C144 gradation is, however, not required and sand that is clean, fine, well graded and without pebbles or large aggregate will suffice.

The balance of the remaining ingredients of the composite material is comprised of cellulosic wood fibers. However, unmodified cellulosic fibers are not suitable as reinforcement for pozzolanic binders in their natural state due to the harsh alkaline environment of the binder mixture. Such alkaline conditions tend to degrade the fibers as soon as they are introduced into the mixture and before it has a chance to set and cure. Maintenance of the physical integrity of cellulosic wood fibers during the curing stages of a pozzolanic binder mixture is necessary for the fibers to reinforce the cured composition. The chemically purified cellulose fibers of this invention are capable of withstanding the harsh alkaline environment and become firmly bonded in the pozzolanic binder matrix.

As used herein, “chemically treated” means treated with mineralizing agents and preferably treated by a solution of aluminum sulfate in water. Given wood fibers with an initial moisture content of about 15-25% (atro basis), the aluminum sulphate is mixed in an aqueous solution at about 2.5% by weight relative to the wood fiber and sprayed on the wood fibers to the point of saturation. The saturated wood chips are continuously or periodically mixed and maintained in the treatment solution for at least one and preferably 24 hours in order for mineralization to occur. This results in removal of residual sugar at and near the surface of the wood so as to permit bonding with and encapsulation by the cementitious binders of the acoustical mixture. Other mineralizing agents are acceptable, and may be selected from among the group of aluminum sulphate, sodium sulphate, potassium sulphate, sodium phosphate, potassium phosphate, sodium chloride and potassium chloride.

Specifically, chemically mineralized wood chips and/or particles may be comprised of softwoods chips or hardwoods, or a combination of the two. The softwood chips and/or particles, if included, may be loblolly pine softwood chips and/or particles treated with the mineralizing compound as described to increase the stability of the cellulose wood fiber in an alkaline environment. The hardwood chips and/or particles, if included, are similarly chemically treated chips from surplus logs, wood pallets, or wood waste of any species or variety and which are commonly purchased in bulk, often as industrial waste products. The chemically mineralized wood chips and/or particles (hardwood chips and/or particles, softwood chips and/or particles, or a combination of the two) are provided within a range of from 10%-65% inclusive by total composition volume, 55% being presently preferred.

The wood-based construction waste is similarly chemically mineralized and may be derived from recycled industrial wood-based construction materials such as plywood, particle board, wafer board, trim, framing lumber, off-cuts, Masonite, hardwood flooring, treated lumber, plastic lumbers and bamboo. Generally, recycled wood-based waste requires chipping, grinding, or fiberizing to reduce the non-homogeneous raw material into a uniform material for mineralizing and incorporation into the present invention. A maximum particulate size of ⅛″×1″ is desirable with ⅛″×¾″ preferred. The chemically mineralized wood-based construction waste is provided within a range of from 5%-20% inclusive by total composition volume, 10% being presently preferred.

The chemically mineralized cellulosic wood fibers are combined in bulk into the pozzolanic binder and sand and the entire mixture blended for approximately 30 seconds prior to the incorporation of sufficient water to initiate the binder reaction and to achieve the desired workability and slump of the mixture. Approximately 30 gallons of water per cubic yard is preferable, subject to adjustment as is known in the industry to accommodate variations in material and ambient conditions. The hydrated mixture is further blended for several minutes to yield a fully integrated but uncured composition of the present invention, which may then be cast alone into panels or monolithically cast to one or both sides of a structural or precast panel for added structural strength. The composition when used with or without a structural backing is very durable and weather resistant. The product meets or exceeds the State DOT and FHA specification requirements for the following ASTM standards: E90-02, E84-04, C672/C, C672M-03, C666, and C423-02a. When cast against a reinforced concrete structure the end product can be used in all highway conditions and can meet all required wind loads. The product is lightweight yet strong, and due to these properties, the product when properly cured, can be attached to an existing reflective wall resulting with a desired absorptive facing.

The product when properly cured exhibits the following properties when tested in accordance with the cited ASTM standards:
[ASTM C423-02a] Noise Reduction Coefficient (NRC)=0.70 (2″-2¼″ product thickness)
[ASTM C423-02a] Noise Reduction Coefficient (NRC)=0.80 to 0.85 (3″ product thickness)
[ASTM E90-02] STC of 46 when product is backed with 5″ of concrete
[ASTM E84-04] Flame Spread=0, Smoke Developed Index=5
[ASTM C666] Freeze/Thaw=Minimal loss after 300 cycles
[ASTM C672/C672M-03] Salt Scaling=No visible damage after 50 cycles

Moreover, the cured composition is corrosion resistant, vermin proof, it will not decompose, it is free draining, and exhibits insignificant capillary suction.

The primary use for the present composition is for highway sound barrier walls but the product can also be used in any application where a durable sound absorptive material is required. For example, the composition can be poured (cast) and cured for use as an absorptive panel, or cast monolithically with reinforced concrete to form a structural and absorptive precast concrete panel.

Having now set out exemplary embodiments of the present invention, it should be understood that the invention may be used with a variety of other materials and components. Consequently, while this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

I claim:

1. A composite acoustical sound barrier material comprising
25%-40% by volume pozzolanic binder,
10%-65% by volume chemically mineralized wood chips and/or particles,
5%-25% by volume chemically mineralized wood based construction waste, and
5% by volume mortar sand.

2. The composite acoustical sound barrier material of claim 1 wherein said pozzolanic binder comprises 30% by volume.

3. The composite acoustical sound barrier material of claim 1 wherein said chemically mineralized wood chips and/or particles comprises 55% by volume.

4. The composite acoustical sound barrier material of claim 1 wherein said chemically mineralized wood based construction waste comprises 10% by volume.

5. The composite acoustical sound barrier material of claim 1 further comprising 0.1%-5% fly ash, ground slag or fumed silica.

6. The composite acoustical sound barrier material of claim 1 wherein said chemically mineralized wood chips and/or particles are further comprised of hardwood chips and/or particles, softwood chips and/or particles or a combination of the two and wherein said chemically mineralized wood chips and/or particles have a maximum size of ⅛″×1″.

7. The composite acoustical sound barrier material of claim 1 wherein said wood based construction waste further comprises plywood, particle board, wafer board, trim, framing lumber, off-cuts, Masonite, hardwood flooring, treated lumber, plastic lumbers, bamboo or other post consumer construction waste.

8. The composite acoustical sound barrier material of claim 7 wherein said wood based construction waste has a maximum particulate size of ⅛″×1″.

9. An acoustical sound barrier comprising
a structural layer of reinforced concrete, and
a first sound attenuation layer affixed to a first side of said structural layer, said sound attenuation layer fabricated of a mixture comprising
25%-40% by volume pozzolanic binder,
10%-65% by volume chemically mineralized wood chips and/or particles,
5%-25% by volume chemically mineralized wood based construction waste, and
5% by volume mortar sand.

10. The acoustical sound barrier of claim 9 wherein said structural layer of reinforced concrete is a precast panel.

11. The acoustical sound barrier of claim 9 wherein said structural layer of reinforced concrete is monolithically cast with said sound attenuation layer.

12. The acoustical sound barrier of claim 9 wherein said structural layer of reinforced concrete is a precast panel.

13. The acoustical sound barrier of claim 9 further comprising a second sound attenuation layer affixed to a second side of said structural layer, said sound attenuation layer fabricated of a mixture comprising
25%-40% by volume pozzolanic binder,
10%-65% by volume chemically mineralized wood chips and/or particles,
5%-25% by volume chemically mineralized wood based construction waste, and 5% by volume mortar sand.

14. An acoustical sound attenuating facing comprising
a sound attenuation layer fabricated of a mixture comprising
25%-40% by volume pozzolanic binder,
10%-65% by volume chemically mineralized wood chips and/or particles,
5%-25% by volume chemically mineralized wood based construction waste, and
5% by volume mortar sand
said sound attenuating facing adapted for affixing to an existing structural layer by mechanical fasteners.

15. A method of making a composite acoustical sound barrier material comprising the steps of
preparing a formwork in the desired shape of the barrier,
obtaining softwood and/or hardwood material,
processing said softwood and/or hardwood into chips having a maximum size of ⅛″×1″,
saturating said softwood and/or hardwood chips in a mineralizing agent for not less than 1 hour,
obtaining wood based construction waste materials from post-consumer sources,
processing said wood based construction waste materials into chips having a maximum size of ⅛″×1″,
saturating said wood based construction waste materials in a mineralizing agent for not less than 1 hour,
mixing said softwood and/or hardwood chips and said wood based construction waste materials with a pozzolanic binder and mortar sand in the following ratio:
25%-40% by volume pozzolanic binder,
10%-65% by volume chemically mineralized wood chips and/or particles,
5%-25% by volume chemically mineralized wood based construction waste,
5% by volume mortar sand,
adding water to said mixture and further mixing to homogenize said mixture,
placing a layer of said mixture in said formwork,
tamping said layer in place, and
stripping said formwork after said layer has cured.

16. The method of making a composite acoustical sound barrier material according to claim 15, further comprising the steps of
prior to said curing of said layer of said mixture, pouring a layer of concrete over said layer of said mixture in said form, said layer of concrete reinforced by incorporated steel bars.

17. The method of making a composite acoustical sound barrier material according to claim 16, further comprising the steps of placing a second layer of said mixture over said layer of concrete in said formwork, and
tamping said second layer of said mixture in.
